(19) United States
(12) Patent Application Publication
(10) Pub. No.: US 2009/0129443 A1
(43) Pub. Date: May 21, 2009

(54) Multi-Channel Transmission System, Transmitting Apparatus and Transmitting Method

(76) Inventor: Toshinori Suzuki, Fujimino-shi (JP)

Correspondence Address: EDWARDS ANGELL PALMER & DODGE LLP, P.O. BOX 55874, BOSTON, MA, 02205, US

(21) Appl. No.: 11/922,868

(22) PCT Filed: Jun. 26, 2006
(86) PCT No.: PCT/JP2006/312704

§ 371 Date: Dec. 26, 2007

(30) Foreign Application Priority Data
Jun. 27, 2005 (JP) 2005-186571

(51) Int. Cl. H04B 1/00

(52) U.S. Cl. 375/133; 375/135; 375/E01.033

(57) ABSTRACT

A transmitter (1) comprises a spreading code generating part (11) that uses the set values of adjacent parameters to generate spreading codes from a row or column vector in a spreading code matrix comprising trigonometric functions the arguments of which are the adjustment parameters; and a signal multiplexing part (12) that performs spread and multiplex processes of information using the spreading codes. The transmitter (1) arranges the signals, which have been subjected to the spread and multiplex processes, onto a plurality of subchannels for transmission.

### TECHNICAL FIELD

The present invention relates to a multi-channel transmission system, a transmitting apparatus and a transmitting method.

Priority is claimed on Japanese Patent Application No. 2005-186571, filed Jun. 27, 2005, the content of which is incorporated herein by reference.

### BACKGROUND ART

Conventional multi-channel transmission systems that perform multiplex transmission using a plurality of subchannels include, for example, a multi-channel transmission system that constitutes subchannels by frequency-division of carriers, and known methods include Orthogonal Frequency Division Multiplexing (OFDM), Multi Carrier-Code Division Multiplexing (MC-CDM), Orthogonal Frequency and Code Division Multiplexing (OFCDM).

The OFDM method frequency-multiplexes a signal using orthogonal subcarriers, and does not perform spread processes of information using orthogonal codes. The MC-CDM method uses subcarriers to frequency-multiplex a signal that is spread in the frequency domain using orthogonal coding. The OFCDM method is one type of MC-CDM method, which uses orthogonal codes to spread information in the frequency domain or the time domain, and also frequency-multiplexes the signal using orthogonal subcarriers.

Of these methods, those that use orthogonal codes to spread in the frequency domain (MC-CDM and OFCDM that spreads in the frequency domain) are advantageous in that they can generally obtain a frequency diversity effect and have good characteristics of receiving modulated symbols. However, they are problematic in that when the orthogonality between codes is lost due to the frequency selectability of the radio transmission path, inter-code interference thereby generated causes the reception characteristics to deteriorate. See, for example D. Garg and F. Adachi, ‘Diversity-coding-orthogonality trade-off for coded MC-CDMA with high level modulation’, IEICE Trans. Commun., vol. E98-B, No. 1, pp. 76-83, January 2005.

As for the method of spreading in the time domain using orthogonal codes (OFCDM spreading in the time domain) and the OFDM method that does not spread, although there is little effect from inter-code interference, these methods do not obtain frequency diversity.

In the conventional multi-channel systems mentioned above, when obtaining frequency diversity by spreading in frequency domain, there is a problem of inter-code interference, and when not spreading in the frequency domain, there is a problem that frequency diversity cannot be obtained; either way, transmission quality is affected. There is a consequent problem that transmission quality is liable to become unstable as a result of change in the state of the transmission path

### DISCLOSURE OF THE INVENTION

The positional information has been realized in consideration of the above circumstances, and aims to provide a multi-channel transmission system, a transmitting apparatus, and a transmitting method, which can stabilize transmission quality by enabling diversity and inter-code interference to be adjusted.

In order to achieve the above objects, a multichannel transmission system according to the invention includes a transmitting apparatus comprising spreading code generating means that uses set values of adjustment parameters to generate spreading codes from a row or column vector in a spreading code matrix comprising trigonometric functions the arguments of which are the adjustment parameters, signal multiplexing means that performs spread and multiplex processes of intonation using the spreading codes, and transmitting means that arranges signals which have been subjected to the spread and multiplex processes onto a plurality of subchannels for transmission; and a receiving apparatus comprising receiving means that receives signals on the plurality of channels transmitted from the transmitting apparatus, and signal dividing means that performs a signal division process to the received signals using same spreading codes as the transmitting apparatus.

In the multi-channel transmission system according to the invention, the spreading code matrix is an orthogonal matrix.

In the multi-channel transmission system according to the invention, the spreading code matrix is a rotation matrix, and the adjustment parameters are rotation angles thereof.

In multi-channel transmission system according to the invention, when arranging the signals which have been subjected to the spread and multiplex processes onto the plurality of subchannels, the transmitting means arranges a pair of spread subcarriers as far away from each other as possible on the frequency axis.

A transmitting apparatus according to the invention includes spreading code generating means that uses set values of adjustment parameters to generate spreading codes from a row or column vector in a spreading code matrix comprising trigonometric functions the arguments of which are the adjustment parameters, signal multiplexing means that performs spread and multiplex processes of information using the spreading codes, and transmitting means that arranges signals which have been subjected to the spread and multiplex processes onto a plurality of subchannels for transmission.

In the multi-channel transmission system according to the invention, the spreading code matrix is an orthogonal matrix.

In the multi-channel transmission system according to the invention, the spreading code matrix is a rotation matrix, and the adjustment parameters are rotation angles thereof.

In the multi-channel transmission system according to the invention, the when arranging the signals which have been subjected to the spread and multiplex processes onto the plurality of subchannels, the transmitting means arranges a pair of spread subcarriers as far away from each other as possible on a frequency axis.

A transmitting method according to the invention includes a spreading code generating step of using set values of adjustment parameters to generate spreading codes from a row or column vector in a spreading code matrix comprising trigonometric functions the arguments of which are the adjustment parameters, a signal multiplexing step of performing spread and multiplex processes of information using the spreading codes; and a transmitting step of arranging signals which have been subjected to the spread and multiplex processes onto a plurality of subchannels for transmission.

In the transmitting method according to the invention, the spreading code matrix is an orthogonal matrix.

In the transmitting method according to the invention, the spreading code matrix is a rotation matrix, and the adjustment parameters are rotation angles thereof.

In the transmitting method according to the invention, when arranging the signals which have been subjected to the spread and multiplex processes onto the plurality of subchannels, a pair of spread subcarriers is arranged as far away from each other as possible on a frequency axis.

According to the invention, diversity and inter-code interference can be adjusted using the set values of the adjustment parameters. This enables the transmission quality to be stabilized.

### BRIEF DESCRIPTION OF THE DRAWINGS

FIG. 1 is a block diagram of a multi-channel transmission system according to an embodiment of the invention.

FIG. 2A is an explanatory diagram of a case where two subchannels are formed by time division.

FIG. 2B is an explanatory diagram of a case where two subchannels are formed by frequency division.

FIG. 2C is an explanatory diagram of a case where two subchannels are formed by space division.

FIG. 3 is a block diagram of an example of a multi-channel transmission system according to an embodiment of the invention.

FIG. 4 is a coordinate diagram for explanation of the relationship between signal points 501 to 504 and a receiving point R in a QPSK system.

FIG. 5 is an explanatory diagram of a subcarrier arranging method according to the invention.

### REFERENCE CODES

1, 100 Transmitter

2, 200 Receiver

11, 101 Spreading code generating unit

12, 103 Signal multiplexing unit

13, 207 Signal dividing unit

102 Modulator

105 Inverse Fourier transforming unit

208 Demodulator

### BEST MODE FOR CARRYING OUT THE INVENTION

An embodiment of the invention will be explained with reference to the drawings.

To begin with, a method of creating a spreading code according to the invention will be explained.

Firstly, a spreading code matrix R_{N} is created. Equation (1) expresses the spreading code matrix R_{N} when the spread rate is 2^{N} (where N is an integer of 1 or more).

$${R}_{N} = ( \begin{matrix}{R}_{N - 1} cos ( {p}_{N} ) & {R}_{N - 1} sin ( {p}_{N} ) \\ - {R}_{N - 1} sin ( {p}_{N} ) & {R}_{N - 1} cos ( {p}_{N} )\end{matrix} ) \qquad ( 1 )$$

Here, p_{N} is an adjustment parameter. The range (in units of radians) of the adjustment parameter is q×π/4≦p_{N}≦(q+1)×π4 (where q is an integer). At a spread rate of 2^{N}, there are N adjustment parameters ‘p₁, p₂, . . . , p_{N}’.

As a specific example of the spreading code matrix R_{N}, Equation (2) expresses a spreading code matrix R₁ when ‘N=1’ (i.e. when the spread rate is 2). Equation (3) expresses a spreading code matrix R₂ when ‘N=2’ (i.e. when the spread rate is 4). In Equation (2) where the spread rate is 2 (N=1), there is one adjustment parameter ‘p₁’. In Equation (3) where the spread rate is 4 (N=2), there are two adjustment parameters ‘p₁ and p₂’.

$$\begin{matrix}{R}_{1} = ( \begin{matrix}cos ( {p}_{1} ) & sin ( {p}_{1} ) \\ - sin ( {p}_{1} ) & cos ( {p}_{1} )\end{matrix} ) & ( 2 ) \\ \begin{matrix}{R}_{2} = ( \begin{matrix}{R}_{1} cos ( {p}_{2} ) & {R}_{1} sin ( {p}_{2} ) \\ - {R}_{1} sin ( {p}_{2} ) & {R}_{1} cos ( {p}_{2} )\end{matrix} ) \\ = ( \begin{matrix}cos ( {p}_{1} ) cos ( {p}_{2} ) & sin ( {p}_{1} ) cos ( {p}_{2} ) & cos ( {p}_{1} ) sin ( {p}_{2} ) & sin ( {p}_{1} ) sin ( {p}_{2} ) \\ - sin ( {p}_{1} ) cos ( {p}_{2} ) & cos ( {p}_{1} ) cos ( {p}_{2} ) & - sin ( {p}_{1} ) sin ( {p}_{2} ) & cos ( {p}_{1} ) sin ( {p}_{2} ) \\ - cos ( {p}_{1} ) sin ( {p}_{2} ) & - sin ( {p}_{1} ) sin ( {p}_{2} ) & cos ( {p}_{1} ) cos ( {p}_{2} ) & sin ( {p}_{1} ) cos ( {p}_{2} ) \\ sin ( {p}_{1} ) sin ( {p}_{2} ) & - cos ( {p}_{1} ) sin ( {p}_{2} ) & - sin ( {p}_{1} ) cos ( {p}_{2} ) & cos ( {p}_{1} ) cos ( {p}_{2} )\end{matrix} )\end{matrix} & ( 3 )\end{matrix}$$

Next, a row or column vector of the spreading code matrix R_{N} is deemed a spreading code. For example, when the spread rate is 2 (N=1), spreading codes v₁ and V₂ expressed in Equation (4) are generated from the row vector of the spreading code matrix R₁ in Equation (2).

v₁=(cos(p₁), sin(p₁))

v₂=(−sin(p₁), cos(p₁)) (4)

The spreading code matrix R_{N} is orthogonal, and its row vectors are orthogonal vectors. Similarly, its column vectors are orthogonal vectors. Therefore, the obtained spreading codes are orthogonal codes.

The spreading code matrix R₁ expressed in Equation (2) is a rotation matrix, the adjustment parameter p₁ being the angle of rotation, The amount of spread of a spreading code according to this invention can be controlled by adjusting the adjustment parameters. For example, when the spread rate is 2 (N=1), if ‘p₁=0’, equation (4) obtains

v₁=(1,0)

v₂=(0,1)

with no signal spread.

When the spread rate is 2 (N=1) and ‘p₁=π/4’, equation (4) obtains

v₁=(1/√2, 1/√2)

v₂=(−1/√2, 1/√2)

whereby the signals are spread at an equal ratio. This corresponds to a Walsh code.

The spreading code matrix R_{N} can be modified using various types of formula based on the characteristics of trigonometric functions. For example, if p1 ‘p1+π’, equation (2) can be modified to equation (5). Similarly, by using a function such as ‘sin(x+π/2)=cos(x)’

It can be configured entirely by single trigonometric functions (e.g. only sine coefficients or only cosine coefficients).

$${R}_{1} = ( \begin{matrix}- cos ( {p}_{1} ) & - sin ( {p}_{1} ) \\ sin ( {p}_{1} ) & - cos ( {p}_{1} )\end{matrix} ) \qquad ( 5 )$$

It is also possible to perform an operation of multiplying the spreading code matrix R_{N} by a constant, and an operation of switching a row or column vector in the spreading code matrix R_{N}. Spreading codes can be created from a matrix created by performing one or both of these operations.

The multi-channel trasmission system according to an embodiment of this invention will be explained, taking as an example spreading codes v₁ and v₂ obtained from the spread rate of 2 (N=1) expressed in equation (4).

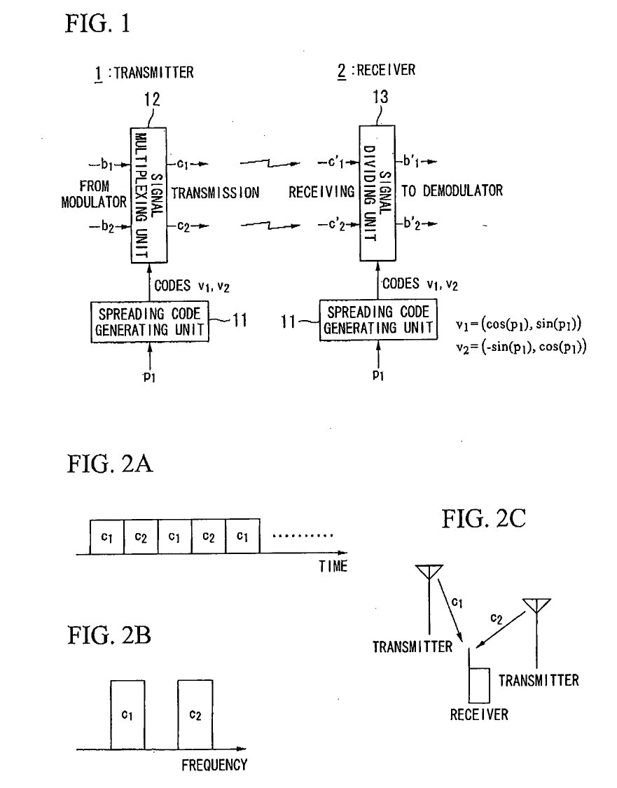

FIG. 1 is a block diagram of a multi-channel transmission system according to an embodiment of this invention,

In FIG. 1, a transmitter 1 includes a spreading code generating unit 11 and a signal multiplexing unit 12.

An adjustment parameters p₁ is set, and input to the spreading code generating unit 11. The spreading code generating unit 11 uses the input adjustment parameter p₁ to compute equation (4), and thereby creates spreading codes v₁ and v₂.

Modulated symbols b₁ and b₂ output from a modulator are input to the signal multiplexing unit 12. In this embodiment, modulated symbols output from a modulator are separated into two systems, one system being modulated symbol b₁, and the other, modulated symbol b₂.

The signal multiplexing unit 12 spreads the modulated symbols b₁ and b₂ using the spreading codes v₁ and v₂. In addition, it multiplexes the signals after they are spread. In these spread and multiplex processes, the computation expressed in equation (6) is performed.

(c₁, c₂) =v₁b₁+v₂b₂=(b₁ cos(p₁)−b₂ sin(p₁), b₁ sin(p₁)+b₂ cos(p₁)) (6)

Here, c₁ and c₂ are subchannels.

When using the spreading codes v₁ and v₂ of equation (4), this multi-channel transmission system must be provided with at least two subchannels; this embodiment uses only two subchannels. The subchannels are formed by performing one of time division, space division, and frequency division, or by performing a plurality of these in combination.

FIG. 2A is an explanatory diagram of a case where two subchannels are formed by time division, FIG. 2B, a case where two subchannels are formed by frequency division, and FIG. 2C, a case where two subchannels are formed by space division.

Subchannels c₁ and c₂ created by the computation of equation (6) are transmitted from the transmitter 1. The transmitted subchannel signals c₁ and c₂ are transmitted on their respective channels and are received as subchannel signals c′₁ and c′₂ at a receiver 2.

The receiver 2 includes a spreading code generating unit 11 and a signal demultiplexing unit 13. The spreading code generating unit 11 of the receiver 2 is identical to the spreading code generating unit 11 of the transmitter 1, and creates spreading codes v₁ and v₂ by performing the computation of equation (4) using adjustment parameter p₁ having the same value as that of the transmitter 1.

Using the spreading codes v₁ and v₂, the signal demultiplexing unit 13 performs a signal division operation to the received subchannels c′₁ and c′₂, and obtains modulated symbols b′₁ and b′₂. Equation (7) is computed during this signal division process.

b′₁=v₁•(c′₁, c′₂)

b′₂=v₂•(c′₁, c′₂) (7)

If equations (6) and (7) indicate that the received signals of the subchannels are identical to the transmitted signals, i.e. that b′₁=c′₂ and c′₂=b′₂, the demodulated symbols will also be identical to the modulated symbols, i.e. b′₁=b₁ and b′₂−b₂.

The demodulated symbols b′₁ and b′₂ when the received signal strengths of the subchannels are a₁ and a₂ are determined from equations (6) and (7) by computation of equation (8). For simplification, effects of background noise are omitted.

b′₁=(a₁×cos²(p₁)+a₂×sin²(p₁))×b₁+(−a₁+a₂)×sin(p₁)×cos(p₁)×b₂

b′₂=(−a₁+a₂)×sin(p₁)×cos(p₁)×b₁+(a₁×sin²(p₁)+a₂×cos²(p₁))×b₂ (8)

As shown by equation (8), according to the spreading codes v₁ and v₂ of this embodiment, diversity and inter-code interference can be adjusted using the set value of the adjustment parameter p₁. This is explained more specifically below.

Firstly, since the range (in radians) of the adjustment parameter p₁ is q×π/4≦p_{N}≦(q+1)×π/4 (where q is an integer), if q=0, then 0≦p₁≦π/4. When p₁=0, Then

b′₁=a₁×b₁ and b′₂=a₂×b₂

and there is no interference between modulated symbols b′₁ and b′₂. However, fluctuation in the received signal strengths a₁ and a₂ of the subchannels affects the levels of the modulated symbols b′₁ and b′₂.

When p₁=π/4,

b′₁=(a₁+a₂)×b₁/2+(−a₁+a₂)×b₂/2

b′₂=(−a₁+a₂)×b₁/2+(a₁+a₂)×b₂/2

Since the intended modulated symbols are received with the received signal strengths a₁ and a₂ of the individual subchannels averaged to a strength of (a₁+a₂)/2, level fluctuation of the demodulated symbols is alleviated in comparison with when p₁=0 (i.e. diversity is obtained). However, unintended modulated symbols intrude at a level (−a₁+a₂)/2 that is half the difference in received signal strength (i.e. inter-code interference is generated).

When 0<p₁<π/4, diversity and inter-code interference can be adjusted to characteristics between those of p₁=0 and p₁=π/4. The effect of such adjustment is particularly noticeable when there is variation in the transmission quality between subchannels.

While in the embodiment described above, the modulated symbols b′₁ and b′₂ are transmitted to the same user, they can be transmitted to different users.

Also, it is possible to use various types of modulation system, such as amplitude shift keying (ASK), phase shift keying (PSK), frequency shift keying (FSK), and quadrature amplitude modulation (QAM).

While the embodiment describes an example of a multi-channel transmission system where the spread rate is 2 and there are two multiplexes, the invention can be applied in any combination of an arbitrary spread rate and an arbitrary number of multiplexes (provided that M and N are integers of 1 or more, and M<2^{N}). In that case, diversity and inter-code interference can be adjusted by setting N number of adjustment parameters p₁, p₂, . . . , p_{N}.

According to the embodiment described above, diversity and inter-code interference can be adjusted based on the set values of the adjustment parameters. This enables the transmission quality to be stabilized.

### EXAMPLES

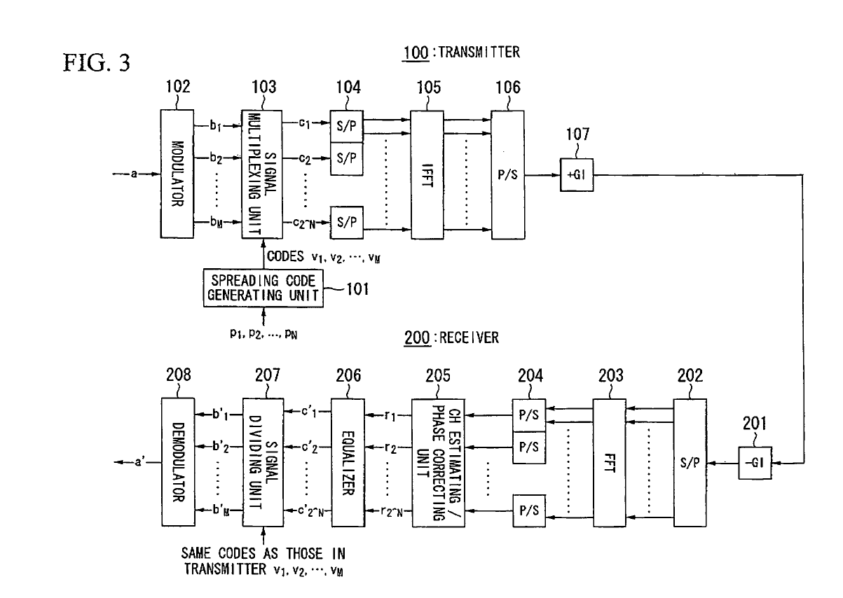

FIG. 3 is an example of a multi-channel transmission system according to the invention, In this example, an MC-CDM system has a spread rate of 2^{N} and the number of multiplexes is M.

In FIG. 3, a transmitter 100 includes a spreading code generating unit 101, a modulator 102, a signal multiplexing unit 103, a serial/parallel converting unit 104, an inverse Fourier transforming unit 105, a parallel/serial converting unit 106, and a guide interval inserting unit 107.

In the transmitter 100 of FIG. 3, the spreading code generating unit 101 uses the N number of adjustment parameters p₁, p₂, . . . , p_{N} inputted thereto in creating N spreading codes v₁, v₂, . . . , v_{N} based on equation (1). Since the number of multiplexes is M, only M of the N spreading codes v₁, v₂, . . . , v_{N} are actually used. Therefore, a number M of spreading codes are arbitrarily selected from the total number N of spreading codes v₁, v₂, . . . , v_{N}. Here it is assumed that a number M of spreading codes v₁, v₂, . . . , v_{M} is selected.

The modulator 102 maps the transmitted data sequence A to one of the M number of modulated symbols b₁ to b_{M}. The signal multiplexing unit 103 performs spread and multiplex processes of the modulated symbols b₁ to b_{M} using the M number of spreading codes v₁, v₂, . . . , v_{M}. In these spread and multiplex processes, equation (9) is computed. This obtains signals on a number 2^{N} of subchannels.

(c₁, c₂, . . . , c₂^{N})=v₁b₁+v₂b₂+ . . . +v_{M}b_{M} 9

The serial/parallel converting unit 104 converts a signal of each subchannel to parallel data. The inverse Fourier transforming unit 105 implements an inverse Fourier transform of the parallel data, transforming it from the frequency-domain to the time-domain. The parallel/serial converting unit 106 converts parallel data output from the inverse Fourier transforming unit 105 to serial data. This serial data is transmitted after a guide interval is inserted therein by the guide interval inserting unit 107. A pilot signal is also inserted into the transmitted signal.

In FIG. 3, a receiver 200 includes a guide interval removing unit 201, a serial/parallel converting unit 202, a fast Fourier transforming unit 203, a parallel/serial converting unit 204, a transmission path estimating (channel (CH) estimating)/phase correcting unit 205, an equalizer 206, a signal dividing unit 207, and a demodulator 208.

The receiver 200 of FIG. 3 uses the same spreading codes v₁, v₂ . . . , v_{N} that were used in the transmitter 100. These can be created by providing the receiver 200 with a spreading code generating unit 101 similar to that of the transmitter 100, or they can be received from the transmitter 100.

The mobile terminal device 200 receives a signal transmitted from the transmitter 100. The guide interval removing unit 201 removes the guide interval from the received signal, and the serial/parallel converting unit 202 converts it to parallel data. The fast Fourier transforming unit 203 implements a fast Fourier transform-to the parallel data, transforming it from the time-domain to the frequency-domain. This converts it to a subchannel signal. The parallel/serial converting unit 204 converts the parallel data output by the fast Fourier transforming unit 203 to serial data.

The CH estimating/phase correcting unit 205 is estimates a phase amount that changes on the transmission path from the subchannel signal output by the parallel/serial converting unit 204, corrects the phase of the subchannel signal based on that estimation, and determines an amplitude value of the corresponding transmission path. Using the amplitude value, the equalizer 206 performs a signal equalization process of the 2^{N} number of subchannel signals r₁, r₂, . . . that were phase-corrected. Minimum mean squared error (MMSE) method can, for example, be used in the signal equalization process.

The signal dividing unit 207 performs a signal division operation to the 2^{N} number of equalized subchannel signals c′₁, c′₂, . . . , using the M number of spreading codes v₁, v₂, . . . , v_{M}, and obtains M number of demodulated symbols b′₁ to b′_{M}. In this signal division process, equation (10) is computed.

b′_{M}=vₘ•(c′₁, c′₂, . . . , c′_{2̂N}) where m=1,2, . . . ,M (10)

The demodulator 208 demodulates the M number of demodulated symbols b′₁ to b′_{M}, obtaining received data sequence A′.

Subsequently, another example of the invention will be explained.

A signal point can be determined with fine positioning by introducing the same number of parameters as spread rates into the spreading code matrix. For example, using a rotational orthogonal matrix of equation (11), the spreading code matrix T₄ when the spread rate is 4 can be expressed by equation (12).

$$\begin{matrix}{T}_{2} ( p ) = ( \begin{matrix}cos ( p ) & sin ( p ) \\ - sin ( p ) & cos ( p )\end{matrix} ) & ( 11 ) \\ {T}_{4} ( {p}_{1} {p}_{2} {p}_{3} {p}_{4} ) = ( \begin{matrix}{T}_{2} ( {p}_{1} ) cos ( {p}_{4} ) & {T}_{2} ( {p}_{2} ) sin ( {p}_{4} ) \\ - {T}_{2} ( {p}_{3} ) sin ( {p}_{4} ) & {T}_{2} ( {p}_{2} + {p}_{3} - {p}_{1} ) cos ( {p}_{4} )\end{matrix} ) & ( 12 )\end{matrix}$$

Even when the spread rate is not a power of two, it is still possible to construct a spreading code matrix comprising trigonometric functions. As an example of this, equation (13) expresses a spreading code matrix obtained with a spread rate of 3.

$$( \begin{matrix}cos [ p ] cos [ r ] & - sin [ p ] sin [ q ] sin [ r ] & cos [ q ] sin [ p ] & cos [ r ] sin [ p ] & sin [ q ] + cos [ p ] sin [ r ] \\ - cos [ r ] sin [ p ] & - cos [ p ] sin [ q ] sin [ r ] & cos [ p ] cos [ q ] & cos [ p ] cos [ r ] & sin [ q ] - sin [ p ] sin [ r ] \\ - cos [ q ] sin [ r ] & & - sin [ q ] & cos [ q ] cos [ r ] & \end{matrix} ) \qquad ( 13 )$$

In equation (13), the row vectors (i.e. the spreading codes) are orthogonal, irrespective of angles p, q, and r, If angles p, q, and r are set as p=0, q=0, and r=0, equation (13) becomes a unit matrix, obtaining normal unspread OFDM signals. As the angles p, q, and r are increased from zero, the transmitted bits are spread onto the subchannels by an amount equivalent to the amount of increase, with resulting increases in diversity and inter-code interference. Excellent communication can be realized by setting the values of p, q, and r such as to achieve optimal balance in this tradeoff between diversity and inter-code interference.

This ability to be flexibly applied in creating a spreading code matrix comprising trigonometric functions, even when the spread rate is not a power of two, is one characteristic effect of the invention. This effect cannot be obtained in the prior art, which uses Walsh codes defined only in powers of two.

Since a normal non-spread OFDM signal cannot be obtained with a complex spreading code such as that shown in equation (14), adjustment of inter-code interference is limited to an extremely narrow adjustment range.

$${R}_{2} = \frac{1}{\sqrt{2}} ( \begin{matrix}1 & {e}^{j \frac{π}{4}} \\ 1 & {e}^{j \frac{5 π}{4}}\end{matrix} ) \qquad ( 14 )$$

In the case of equation (14), since the size of each element of the spread matrix is a fixed value of 1√2, the matrix will not be diagonal no matter how the angles are set. Therefore, a normal OFDM signal cannot be obtained. For this reason, complex spreading codes restrict the adjustment range of inter-code interference to an extremely narrow range, Incidentally, while the angles (in radians) in equation (14) are fixed at π/4 and π/5, the matrix will not become diagonal even if these angles are changed, and therefore a normal OFDM signal cannot be obtained.

However, since the spreading code matrix of this invention comprises trigonometric functions, if the angles of those trigonometric functions are all set to 0 by setting the adjustment parameters, a non-spread diagonal matrix can be obtained. Moreover, if the angles of the trigonometric functions are increased from 0 using the adjustment parameters, it becomes possible to freely adjust the balance between diversity and inter-code interference, and the desired balance can be achieved.

When using a complex spreading code, even if the spread rate is the same, demodulation computation process is complex in comparison with when using the spreading code according to the invention. This point will be explained below. Here, quadrature phase shift keying, or quadrature i-phase shift keying, (QPSK) is used as the modulation method.

A QPSK symbol is expressed as a complex number bn. One bit is allocated for the actual unit (I channel) of the complex number bn, and one bit is allocated for the imaginary unit (Q channel). According to the spreading code of the invention, as shown above in equation (6), when the spread rate is 2, two QPSK symbols b1 and b2 are allocated respectively to subcarriers c1 and c2, If Re(x) expresses the real unit of x and Im(x) expresses the imaginary unit, the real units Re(c1) and Re(c2) and the imaginary units Im(c1) and Im(c2) of the subcarriers c1 and c2 are expressed as follows.

Re(c1)=Re(b1)cos(p1)−Re(b2)sin(p1)

Im(c1)=Im(b1)cos(p1)−Im(b2)sin(p1)

Re(c2)−Re(b1)sin(p1)−Re(b2)cos(p1)

Im(c2)=Im(b1)sin(p1)−Im(b2)cos(p1)

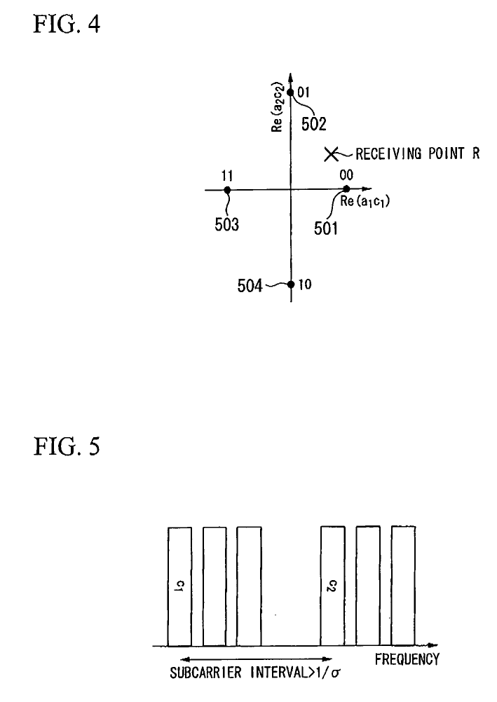

Here, to demodulate the bit allocated to Re(b1), a received signal affected by Re(b1) is considered. Specifically, since subcarrier signals Re(c1) and Re(c2) are affected by Re(b1), these two signals should be considered simultaneously. To facilitate understanding, this will be explained using FIG. 4.

FIG. 4 is a coordinate diagram for explanation of the relationship between reference signal points 501 to 504 and a receiving point R in a QPSK system. Subcarriers c1 and c2 have received signal strengths of a1 and a2. To facilitate explanation, the rotation angle θ (in radians) is π/4. While values of the received signal strengths a1 and a2 generally differ depending on frequency selectability, in FIG. 4 it is assumed that a2>a1.

Since the bits that affect Re(c1) and Re(c2) are the two bits of Re(b1) and Re(b2), signal points to which transmission is possible (known as reference signal points) are the four signal points 501 to 504. The received signal strengths a1 and a2 can be determined on the receiving side by channel estimation and the like. In FIG. 4, receiving point R indicates the values of Re(c1) and Re(c2). With no noise, the receiving point R ought to match one of the four signal points 501 to 504; normally however, it does not match any of them due to noise.

Accordingly, an appropriate conventional demodulating method is performed by measuring the distances between the receiving point R and the four signal points 501 to 504, and deeming that the nearest reference signal point is the transmission point. That is, four distances must be calculated in order to demodulate Re(b1). In this example, since subcarrier signals Re(c1) and Re(c2) are affected by Re(b2), Re(b2) can also be determined by the same distance calculation. That is, two bits can be modulated by four distance calculations. The same applies when the rotation angle (in radians) is a value other than π/4.

In contrast, when using a complex spreading code, the relationship between the modulated symbols and the subcarriers is expressed as equation (15)

$$( {c}_{1} , {c}_{2} ) = \frac{1}{\sqrt{2}} ( {b}_{1} + {b}_{2 } {e}^{j \frac{π}{4}} , {b}_{1} + {b}_{2} {e}^{j \frac{5 π}{4}} ) \qquad ( 15 )$$

While Re(c1) and Re(c2) must be considered in order to demodulate Re(b1), when using a complex spreading code, as shown by equation (15), two other bits Re(b2) and Im(b2) affect the subcarrier signals Re(c1) and E(c2). That is, there are eight reference signal points (three bits). Therefore, when using a complex spreading code, eight distances between reference signal points and the receiving point R must be calculated in order to demodulate R(b1). Furthermore, since Re(b2) affects not only subcarrier signals Re(c1) and Re(c2) but also Im(c1) and Im(c2), Re(b2) cannot be adequately demodulated merely by calculating eight distances when demodulating Re(b1).

Thus according to the spreading code of the invention, demodulation computation process can be made simpler than when using a complex spreading code. This can increase the efficiency of the receiver.

Subsequently, one technological characteristic of the invention will be explained.

In the invention, as described above, a desired balance between diversity and inter-code interference can be realized. This obtains the excellent effect of stabilizing transmission quality in the multi-carrier transmission system. In particular, a characteristic feature of the invention is that it requires no band or function for control, and can be applied in communications requiring low-delay and communications in a high-speed mobile environment.

To stabilize transmission quality in a multi-carrier transmission system, there is a conventional method of allocating an appropriate sub-band irrespective of diversity. This method measures the receive status of a band (a plurality of sub-bands) that can be used for communication, select a suitable sub-band, and use that sub-band for communication. However, this method has disadvantages such as that it takes time to start communication. That is, before starting communication, a plurality of sub-bands must be measured on the receiving side, the measurement results must be reported to the transmitting side, and the sub-band to be used is then determined based on that report; the time taken in measuring, reporting, and determining becomes control delay which delays the start of communication. This method of allocating an appropriate sub-band does not function effectively in an environment where the status of the transmission path changes during the control delay, such as a high-speed mobile environment Moreover, a new transmission path is needed in order to report the measurement results from the receiving side to the transmitting side. When there is no user multiplexing, the unused sub-bands are vacant, and the frequencies cannot be effectively utilized.

However according to the invention, since a band or a function for control are not needed due to the utilization of diversity, the transmission system can be simplified. Moreover, since no unwanted control delay is generated, the invention can be suitably used in communications requiring low-delay and communications in a high-speed mobile environment.

To obtain diversity in a multi-carrier transmission system, to obtain diversity, a pair of spread subcarriers are preferably arranged as far away from each other as possible on the frequency axis. The pair of subcarriers here are subcarriers over which identical modulated symbols are spread, e.g. c1 and c2 in equation (6). Identical modulated symbols b1 and b2 are spread over the subcarriers c1 and c2.

FIG. 5 is an explanatory diagram of a subcarrier arranging method according to the invention. As shown in FIG. 5, an interval between a pair of subcarriers c1 and c2 on a frequency axis is preferably approximately equal to or greater than the reciprocal of the delay spread a of the transmission path. This is because reception states of subcarriers that are near each other on the frequency axis are similar, making it unlikely that there will be diversity even using spread transmission. Generally, delay spread is said to be approximately one microsecond in urban areas, and less than approximately one microsecond indoors. In view of this, it is preferable and more effective if the interval between a pair of subcarriers on the frequency axis is more than approximately 1 MHz when urban communication is envisaged, and more than approximately 10 MHz when indoor communication is envisaged.

While preferred embodiments of the invention have been described and illustrated above, these are not to be considered as limiting, and additions, omissions, substitutions, and other modifications can be made without departing from the spirit or scope of the present invention.

For example, the invention is not limited to a transmission aspect, and can be applied in either of a radio or wired system. It can also be applied in a variety of digital signal transmission systems such as a digital communication system and a digital broadcasting system.

### INDUSTRIAL APPLICABILITY

The invention can be applied in a transmitting apparatus and the like whose transmission quality can be stabilized.

1. A multi-channel transmission system, comprising:
a transmitting apparatus comprising:
a spreading code generating unit that uses set values of adjustment parameters to generate spreading codes from a row or column vector in a spreading code matrix of trigonometric functions having the adjustment parameters as arguments;
a signal multiplexing unit that performs spread and multiplex processes of information using the spreading codes; and
a transmitting unit that arranges signals which have been subjected to the spread and multiplex processes onto a plurality of subchannels for transmission; and
a receiving apparatus comprising:
a receiving unit that receives signals on the plurality of subchannels transmitted from the transmitting apparatus; and
a signal dividing unit that performs a signal division process to the received signals using same spreading codes as the transmitting apparatus.

2. The multi-channel transmission system according to claim 1, wherein the spreading code matrix is an orthogonal matrix.

3. The multi-channel transmission system according to claim 1, wherein the spreading code matrix is a rotation matrix, and the adjustment parameters are rotation angles thereof.

4. The multi-channel transmission system according to claim 1, wherein, when arranging the signals which have been subjected to the spread and multiplex processes onto the plurality of subchannels, the transmitting unit arranges a pair of spread subcarriers as far away from each other as possible on a frequency axis.

5. A transmitting apparatus comprising:
a spreading code generating unit that uses set values of adjustment parameters to generate spreading codes from a row or column vector in a spreading code matrix of trigonometric functions having the adjustment parameters as arguments;
a signal multiplexing unit that performs spread and multiplex processes of information using the spreading codes; and
a transmitting unit that arranges signals which have been subjected to the spread and multiplex processes onto a plurality of subchannels for transmission.

6. The multi-channel transmission system according to claim 5, wherein the spreading code matrix is an orthogonal matrix.

7. The multi-channel transmission system according to claim 5, wherein the spreading code matrix is a rotation matrix, and the adjustment parameters are rotation angles thereof.

8. The multi-channel transmission system according to claim 5, wherein, when arranging the signals which have been subjected to the spread and multiplex processes onto the plurality of subchannels, the transmitting unit arranges a pair of spread subcarriers as far away from each other as possible on a frequency axis.

9. A transmitting method comprising:
setting adjustment parameters;
using the adjustment parameters to generate spreading codes from a row or column vector in a spreading code matrix of trigonometric functions having the adjustment parameters as arguments;
performing spread and multiplex processes of information using the spreading codes; and
arranging signals which have been subjected to the spread and multiplex processes onto a plurality of subchannels for transmission thereof.

10. The transmitting method according to claim 9, wherein the spreading code matrix is an orthogonal matrix.

11. The transmitting method according to claim 9, wherein the spreading code matrix is a rotation matrix, and the adjustment parameters are rotation angles thereof.

12. The multi-channel transmission system according to claim 9, wherein, when arranging the signals which have been subjected to the spread and multiplex processes onto the plurality of subchannels, a pair of spread subcarriers are arranged as far away from each other as possible on a frequency axis.
